(19) United States
(12) Patent Application Publication
(10) Pub. No.: US 2016/0381583 A1
(43) Pub. Date: Dec. 29, 2016

(54) RADIO BASE STATION, USER TERMINAL AND RADIO COMMUNICATION METHOD

(71) Applicant: NTT DOCOMO, INC., Tokyo (JP)

(72) Inventors: Mamoru Sawahashi, Tokyo (JP); Teruo Kawamura, Tokyo (JP); Yoshihisa Kishiyama, Tokyo (JP)

(73) Assignee: NTT DOCOMO, INC., Tokyo (JP)

(21) Appl. No.: 15/121,693

(22) PCT Filed: Feb. 27, 2015
(86) PCT No.: PCT/JP2015/055904

§ 371 Date: Aug. 25, 2016

(30) Foreign Application Priority Data
Feb. 28, 2014 (JP) 2014-038647

(51) Int. Cl. H04W 24/08; H04B 7/04; H04W 72/04; H04L 5/14

(52) U.S. Cl. CPC H04W 24/08; H04L 5/14; H04B 7/0413; H04B 7/0456; H04W 72/0446

(57) ABSTRACT

The present invention is designed to reduce the overhead of reference signals for measuring CSI in high-order MIMO multiplexing technique. A radio base station is used in a radio communications system of a frequency division duplexing (FDD) scheme, and has a receiving section that receives reference signals for measuring time division duplex (TDD) channel state information, transmitted from a plurality of antennas provided in a user terminal, a measurement section that measures the channel state information, in a plurality of receiving antennas, by using the reference signals, a generation/selection section that generates an optimal precoding vector from the channel state information measured in each receiving antenna, or selects the optimal precoding vector from a set of precoding vectors that is defined in advance, and a transmission section that transmits a physical downlink shared channel, in MIMO multiplexing transmission, by using the precoding vector selected in the generation/selection section.

### TECHNICAL FIELD

The present invention relates to a radio base station, a user terminal and a radio communications method in a next-generation mobile communications system.

### BACKGROUND ART

In the UMTS (Universal Mobile Telecommunications System) network, long-term evolution (LTE) is under study for the purposes of further increasing high-speed data rates, providing lower delays and so on (see, for example, non-patent literature 1). In LTE, as multiple-access schemes, a scheme that is based on OFDMA (Orthogonal Frequency Division Multiple Access) is used for the downlink, and a scheme that is based on SC-FDMA (Single Carrier Frequency Division Multiple Access) is used for the uplink.

Successor systems of LTE—referred to as, for example, “LTE-advanced” or “LTE enhancement”—have been under study for the purpose of achieving further broadbandization and increased speed beyond LTE, and the specifications thereof have been drafted as LTE Rel. 10/11 (LTE-A). To cope with the growing number of subscribers and the growing traffic per user, in LTE and LTE-A, MIMO (Multiple-Input Multiple-Output) multiplexing technique is under study as a radio communication technique to achieve improved cell throughput and spectral efficiency by transmitting and receiving data with a plurality of antennas.

### CITATION LIST

### Non-Patent Literature

Non-Patent Literature 1: 3GPP TR 25.913 “Requirements for Evolved UTRA and Evolved UTRAN”

### SUMMARY OF INVENTION

### Technical Problem

In LTE-A, MIMO multiplexing technique to use maximum eight antennas is stipulated. In MIMO multiplexing, a base station transmits transmitting-antenna-specific orthogonal reference signals (RSs) for measuring CSI (Channel State Information), and a user terminal measures each transmitting antenna's CSI. When the number of transmitting antennas increases, the number of reference signals for measuring CSI also increases, and therefore the resources for transmitting information symbols run short.

The present invention has been made in view of the above, and it is therefore an object of the present invention to provide a radio base station, a user terminal and a radio communication method which can reduce the overhead of reference signals for measuring CSI in high-order MIMO multiplexing technique.

### Solution to Problem

The radio base station of the present invention is a radio base station that is used in a radio communications system of a frequency division duplexing (FDD) scheme, and that has a receiving section that receives reference signals for measuring time division duplex (TDD) channel state information, transmitted from a plurality of antennas provided in a user terminal, a measurement section that measures the channel state information, in a plurality of receiving antennas, by using the reference signals, a generation/selection section that generates an optimal precoding vector from the channel state information measured in each receiving antenna, or selects the optimal precoding vector from a set of precoding vectors that is defined in advance, and a transmission section that transmits a physical downlink shared channel, in MIMO multiplexing transmission, by using the precoding vector selected in the generation/selection section.

### Advantageous Effects of Invention

According to the present invention, it is possible to reduce the overhead of reference signals for measuring CSI in high-order MIMO multiplexing technique.

### BRIEF DESCRIPTION OF DRAWINGS

FIG. 1A is a diagram to explain an overview of an FDD scheme, and FIG. 1B is a diagram to explain an overview of a TDD scheme;

FIG. 2 is a diagram to explain an overview of MIMO multiplexing technique;

FIG. 3 is a diagram to explain an overview of precoding transmission in MIMO multiplexing technique;

FIG. 4 provide diagrams to explain an overview of a subframe configuration;

FIG. 5 is a diagram to explain an overview of CSI measurement and MIMO multiplexing transmission;

FIG. 6 is a diagram to show an example of radio resource allocation in the time domain;

FIG. 7 is a diagram to show an example of radio resource allocation in the frequency domain;

FIG. 8 provide diagram to show the downlink transmission bandwidth in the event a user terminals transmits CSI-RSs on the uplink;

FIG. 9 is a diagram to compare between a method of transmitting transmitting-antenna-specific CSI-RSs, which is a conventional method, and a method of transmitting CSI-RSs by using carrier frequency swapping;

FIG. 10 is a diagram to show an example of a schematic structure of a radio communications system;

FIG. 11 is a diagram to show an example of an overall structure of a radio base station;

FIG. 12 is a diagram to show an example of a functional structure of a radio base station;

FIG. 13 is a diagram to show an example of an overall structure of a user terminal; and

FIG. 14 is a diagram to show an example of a functional structure of a user terminal.

### DESCRIPTION OF EMBODIMENTS

Now, an embodiment of the present invention will be described below in detail with reference to the accompanying drawings. As duplex modes in radio communication in LTE and LTE-A systems, there are frequency division duplex (FDD) to divide between the uplink (UL) and the downlink (DL) based on frequency, and time division duplex (TDD) to divide between the uplink and the downlink based on time.

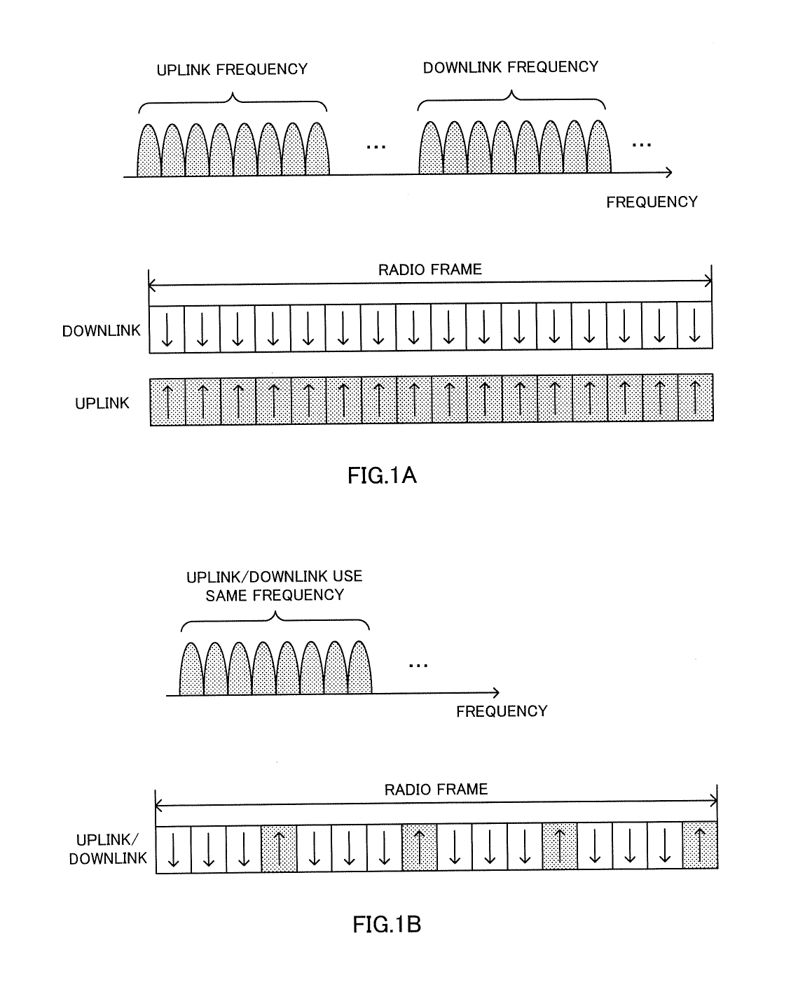

FIG. 1A is a diagram to explain an overview of an FDD scheme. As shown in FIG. 1A, in the FDD scheme, the uplink and the downlink use different frequency bands. Usually, the frequency gap between the uplink and the downlink is approximately 100 [MHz], and the fading variations in the uplink and the downlink show little correlation. In the FDD scheme, the uplink and the downlink transmitting/receiving timings are independent. In the FDD scheme, transmitting signals and received signals are separated by using a duplexer that electrically separates between the transmitting route and the receiving route.

FIG. 1B is a diagram to explain an overview of a TDD scheme. As shown in FIG. 1B, in the TDD scheme, the uplink and the downlink use the same frequency band. Consequently, no paired bands are necessary. The uplink and the downlink use the same carrier frequency, so that the correlation in fading variations is “1” and channel reciprocity can be used. In the TDD scheme, it is necessary to synchronize the uplink and downlink transmitting/receiving timings between cells. This is because the allocation of slots needs to be the same, in the uplink and the downlink, between user terminals located on cell edges and having radio link connections with other base stations. Also, since no duplexer is required in the TDD scheme, it becomes possible to implement user terminals in smaller size.

An advantage of the FDD scheme is that, since timing synchronization between base stations is not necessary, radio resources can be allocated in the uplink or the downlink, independently, per cell, depending on traffic, in a cellular-based multi-cell environment. A disadvantage of the FDD scheme is that the uplink and the downlink require independent frequency bands—that is, paired bands.

An advantage of the TDD scheme is that paired bands are not necessary and the reciprocity of channels can be used. Consequently, the TDD scheme is effective in frequency bands where paired bands cannot be reserved. A disadvantage of the TDD scheme is that timing synchronization is required between cells in a cellular-based multi-cell environment.

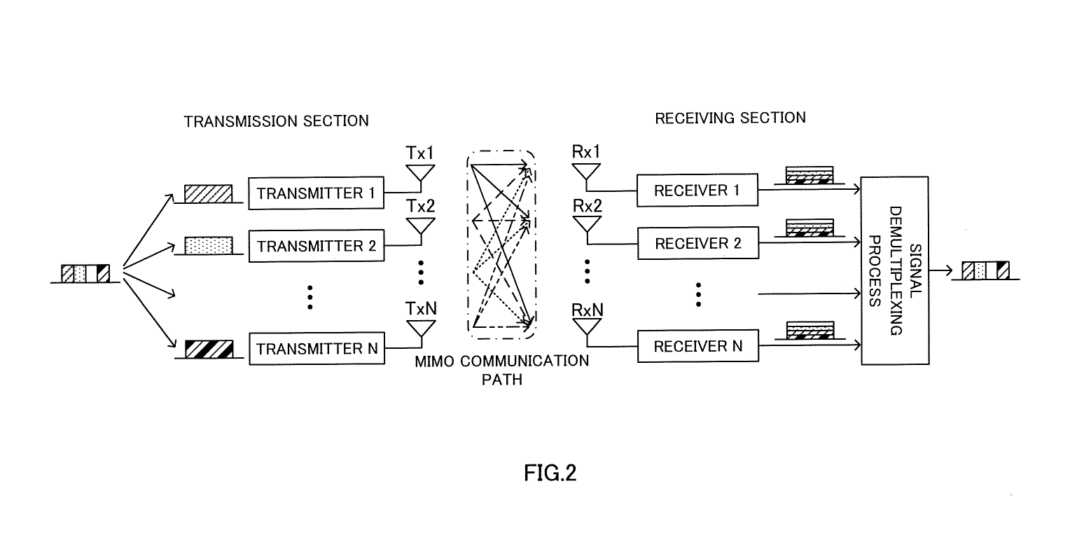

FIG. 2 is a diagram to explain an overview of MIMO multiplexing technique. FIG. 2 shows a structure having a transmission section with N transmitting antennas and a receiving section with N receiving antennas. In the transmission section, signals that vary per transmitting antenna (antenna port) are space-multiplexed and transmitted using the same frequency and time region. The receiving section receives all the transmitting signals in each receiving antenna, so that the original information is acquired by applying a signal demultiplexing process taking advantage of differences in channel variations between the transmitting and receiving antennas.

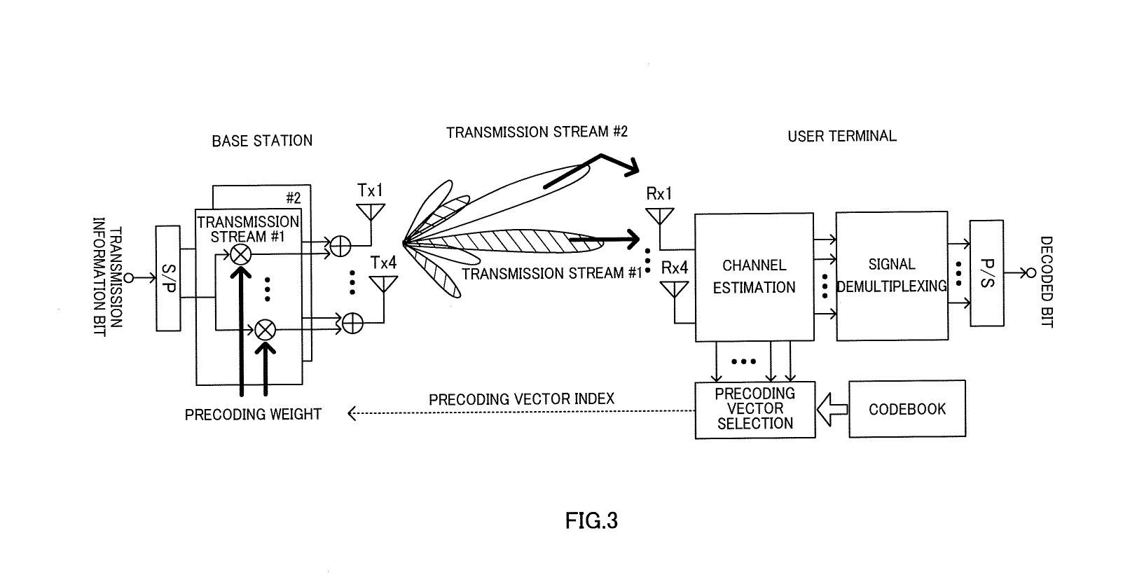

FIG. 3 is a diagram to explain an overview of precoding transmission in MIMO multiplexing technique. In MIMO multiplexing technique, precoding to adaptively multiply each transmitting antenna's information symbol by a weighting coefficient (weight) so that each transmission stream exhibits the maximum received SNR (Signal-to-Noise power Ratio) is carried out. By this means, improved received quality can be achieved by directional transmission.

A user terminal measures each transmitting antenna's CSI, selects the precoding vector that maximizes the received SNR from a set of precoding vectors (codebook) that is defined in advance, and reports this to the base station. Although there are methods of calculating optimal precoding vectors, apart from code book-based precoding, the precoding vector information to feed back to the base station increases. Consequently, in LTE and LTE-A, code book-based precoding is employed. Meanwhile, the base station needs to transmit antenna-specific CSI measurement reference signals in order to allow the user terminal to measure the receiving level from all transmitting antennas. For the transmitting-antenna-specific reference signals, cell-specific reference signals are defined for up to four transmitting antennas, and CSI-RSs are defined for five to eight transmitting antennas.

In the MIMO system shown in FIG. 3, the transmission information bits are distributed into a number of transmission streams as commanded from a higher station apparatus, through a serial-to-parallel converter (S/P) in the base station, provided as a transmission section. After that, in multipliers, manipulation is carried out by multiplying the input signals by precoding weights, and the manipulated signals are each output to an adder. The adders transmit the manipulated signals through transmitting antennas Tx1 to Tx4.

Receiving antennas Rx1 to Rx4 in the user terminal, provided as a receiving section, receive the signals transmitted from one or more transmitting antennas via MIMO propagation paths. The signals received in each receiving antenna are separated into received signals that correspond to respective streams, via a channel estimation section and a signal demultiplexing section. The received signals pertaining to each stream are converted through a parallel-to-serial converter (P/S), providing decoded bits.

In the MIMO system, rank adaptation, which controls the number of transmission streams (rank) depending on the magnitude of the eigenvalues of the channel matrix generated based on the channel response between the transmitting and the receiving antennas.

The precoding vector selection section determines the channel response in each receiving antenna in the event precoding vectors are transmitted from a codebook, which is a set of precoding vectors that is defined in advance—that is, in the event the transmission signals are multiplexed by a precoding matrix—from the channel responses that are estimated using transmitting-antenna-specific reference signals included in the received signals in each receiving antenna. The precoding vector selection section measures the received signal power and the noise power from each receiving antenna's channel response, and calculates the desired signal power-to-noise power ratio (SNR). A precoding vector selection section averages the received SNRs between the receiving antennas, and finds the average received SNR for each precoding vector. Then, the precoding vector selection section selects the precoding vector that maximizes the average received SNR as an optimal precoding vector.

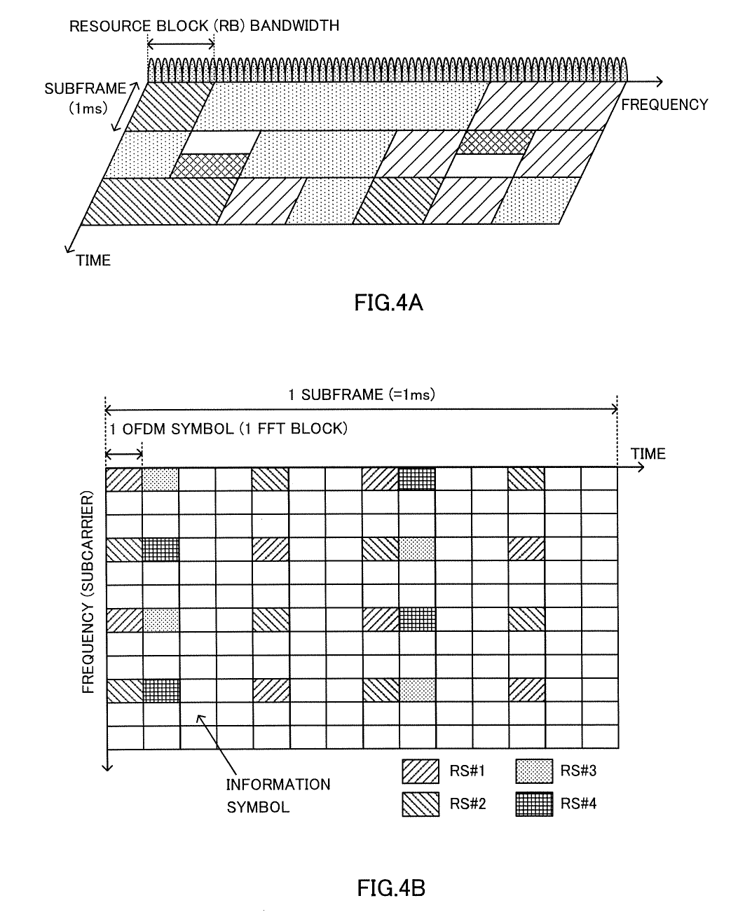

FIG. 4A is a diagram to explain an overview of a subframe configuration. In the LTE system, the base station carries out scheduling to allocate radio resources on a shared data channel to each user having data to transmit/receive. The minimum unit of radio resource allocation is referred to as “resource blocks” (RBs). A subframe is the minimum time unit of scheduling, and resource blocks are allocated to user terminal selected in scheduling per subframe.

FIG. 4B is a diagram to explain an overview of a subframe configuration. One subframe includes fourteen OFDM symbols (FFT (Fast Fourier Transform) blocks) in the time direction, and twelve subcarriers in the frequency direction. In the example shown in FIG. 4B, cell-specific reference signals RS #1 to RS #4 up to an antenna port 4 are arranged according to a multiplexing method that is defined in advance. User information symbols or control information symbols can be arranged in resources where reference signals are not arranged.

Although the maximum number of transmitting antennas in existing LTE-A systems is eight, CSI-RSs, which are different from cell-specific reference signals (CS-RSs) are defined for antenna ports 5 to 8, so that it is no longer necessary to multiplex reference signals for measuring CSI on all resource blocks. However, in resource blocks for a user that carries out MIMO multiplexing transmission with eight transmitting antennas, CSI-RSs for eight antennas need to be multiplexed. The problem then arises that, if, in the future, the number of transmitting antennas increases even more, the number of reference signals for measuring CSI also increases, and the resources for transmitting information symbols run short.

So, the present inventors have found out measuring CSI by using carrier frequency swapping in high-order MIMO multiplexing technique. By this means, it is possible to reduce the overhead of reference signals for measuring CSI in high-order MIMO multiplexing technique. Now, an embodiment of the present invention will be described below in detail

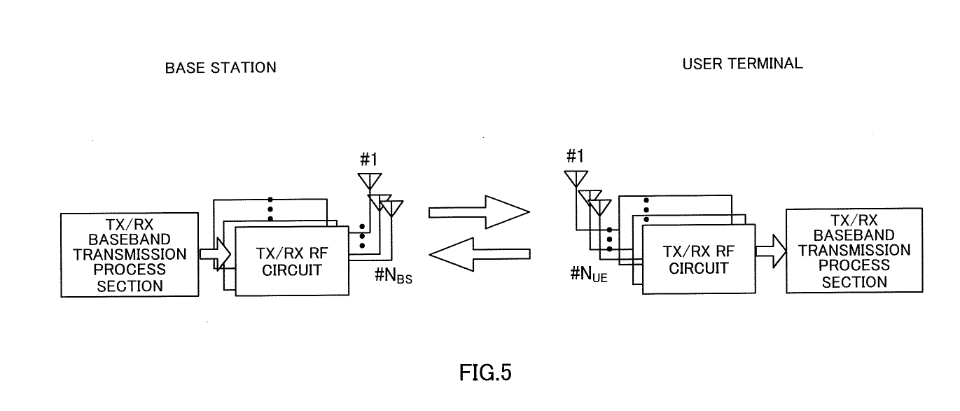

FIG. 5 is a diagram to explain an overview of CSI measurement and MIMO multiplexing transmission. Here, an FDD scheme is presumed. By employing an FDD scheme, it is possible install base stations in a flexible fashion, without establishing synchronization between the base stations. Also, since the uplink and the downlink use different carrier frequencies, the fading variations of the uplink and the downlink are uncorrelated.

Now, existing CSI measurement and MIMO multiplexing transmission will be described using FIG. 5. First, a base station transmits transmitting-antenna-specific reference signals for measuring CSI. A user terminal measures each transmitting antenna's CSI, and selects the precoding vector that maximizes the received SNR from a set of precoding vectors that is defined in advance. The user terminal transmits the selected precoding matrix information, as a selected modulation scheme and a coding scheme (CQI: Channel Quality Indicator), to the base station, on the uplink. The base station transmits the physical downlink shared channel (PDSCH) by using resource blocks that are allocated in downlink scheduling, using precoding vectors reported from the user terminal.

Following this, CSI measurement and MIMO multiplexing transmission to use carrier frequencies according to an embodiment of the present invention will be described with reference to FIG. 5. Although this method can be applied to both the downlink and the uplink, the following description will primarily focus on the downlink.

First, a user terminal transmits TDD CSI-RSs or sounding reference signals, in the downlink carrier frequency (f_{DL}), by using one or a plurality of FFT blocks in an uplink subframe. Presuming PDSCH transmission on the downlink, the base station measures channel response in the frequency domain, in a plurality of receiving antennas, by using the CSI-RSs. The CSI-RSs are transmitted in the downlink carrier frequency, so that the reciprocity of propagation channels can be used. The base station transmits an optimal precoding vector from the CSIs measured per receiving antenna, and transmits the downlink PDSCH using the selected precoding vector.

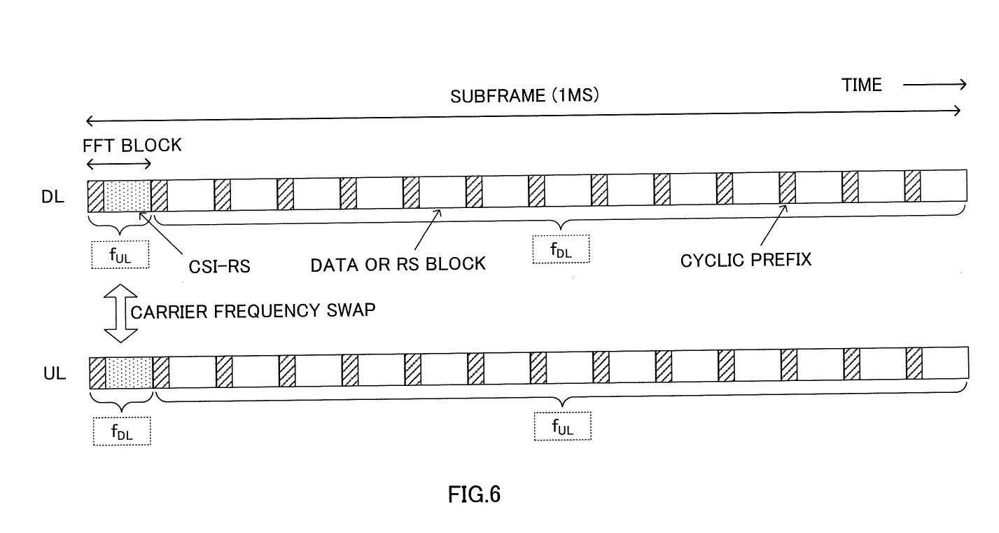

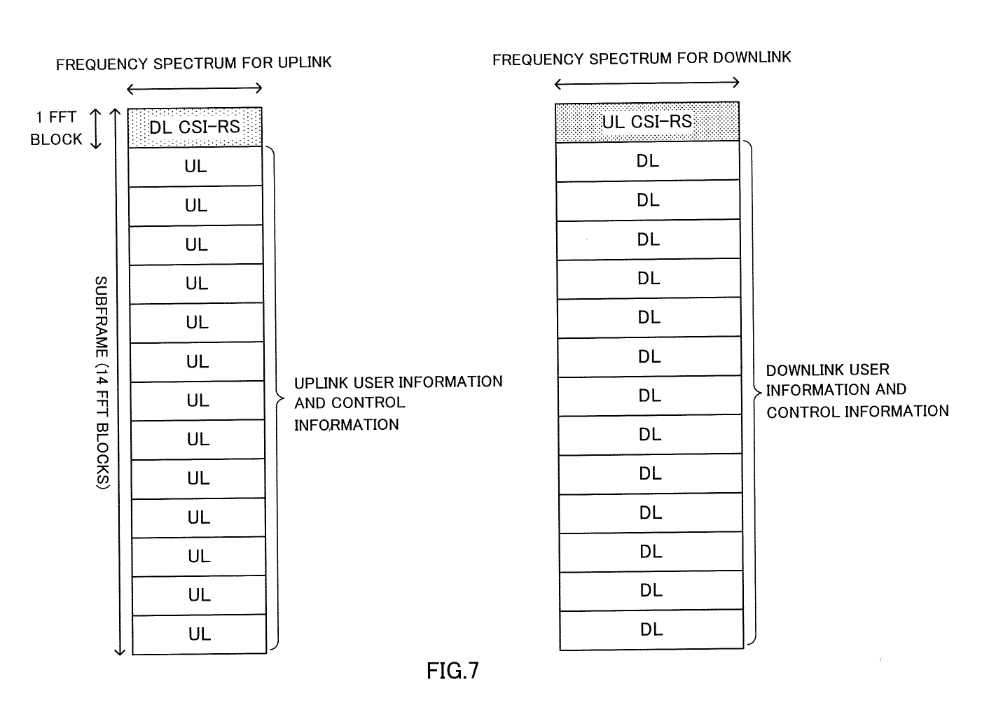

FIG. 6 is a diagram to show an example of radio resource allocation in the time domain according to an embodiment of the present invention. FIG. 7 is a diagram to show an example of radio resource allocation in the frequency domain according to an embodiment of the present invention.

In the example shown in FIG. 6, the CSI-RSs are transmitted using one FFT block at the top. At this time, in the downlink (DL) subframe, the uplink carrier frequency (f_{UL}) is used only in one FFT block at the top, and the downlink carrier frequency (f_{DL}) is used in the rest of the FFT blocks. In the uplink (UL) subframe, the downlink carrier frequency (f_{DL}) is used only in one FFT block at the top, and the uplink carrier frequency (f_{UL}) is used in the rest of the FFT blocks. That is, carrier frequency swapping is employed only in one FFT block at the top.

In the example shown in FIG. 7, CSI-RSs are transmitted using one FFT block at the top. At this time, in the frequency spectrum region for the uplink, the downlink carrier frequency (f_{DL}) is used only in one FFT block at the top, and the uplink carrier frequency (f_{UL}) is used in the rest of the FFT blocks. In the frequency spectrum region for the downlink, the uplink carrier frequency (f_{UL}) is used only in one FFT block at the top. The downlink carrier frequency (f_{DL}) is used in the rest of the FFT blocks. That is, carrier frequency swapping is employed only in one FFT block at the top.

Note that it is also possible to multiplex uplink control information in the transmission period in the uplink frequency spectrum region where the CSI-RS is transmitted using the downlink carrier frequency (f_{DL}). In FFT blocks apart from one FFT block at the top, uplink user information and control information, and downlink user information and control information are allocated to radio resources.

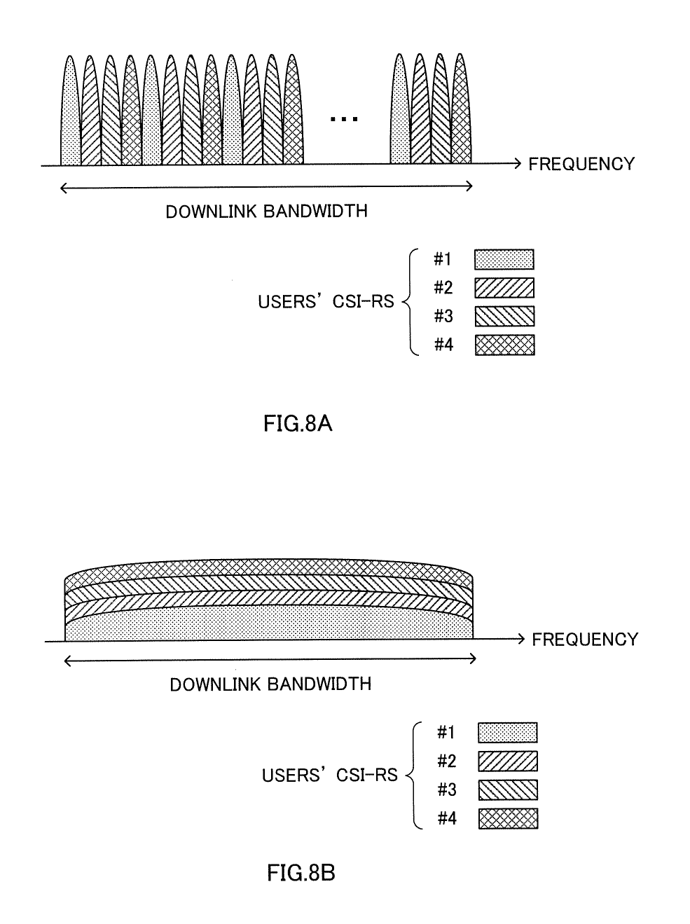

Next, an example of a CSI-RS multiplexing method using carrier frequency swapping in MIMO multiplexing technique will be described. Distributed FDMA is one such example, and orthogonal CDMA is another. In FIG. 8A and FIG. 8B show the downlink transmission bandwidth in the event user terminals transmit CSI-RSs on the uplink by executing carrier frequency swapping.

In distributed FDMA, as shown in FIG. 8A, different user terminals' CSI-RSs are multiplexed over different subcarriers. In single-carrier FDMA, it is possible to transmit CSI-RSs in distributed FDMA, without risking increased peak power. In a frequency-selective fading channel that is subject to multipath fading, the channel response needs to be estimated over the whole band. On the other hand, when a user terminal having low maximum transmission power transmits CSI-RSs from all subcarriers in the transmission bandwidth, the power density per subcarrier becomes low, and this leads to deterioration of the reliability of CSI measurement. However, by transmitting CSI-RSs in discrete subcarriers in distributed FDMA transmission, it is possible to reduce the error in the reliability of CSI measurement. In subcarriers where CSI-RSs are not transmitted, CSI is estimated by way of interpolation.

In orthogonal CDMA, as shown in FIG. 8B, different user terminals' CSI-RSs are multiplexed in orthogonal CDMA. In orthogonal CDMA multiplexing, sequences that are generated by cyclic-shifting a CAZAC (Constant Amplitude Zero Auto-Correlation) sequence having a constant amplitude in the time domain and the frequency domain are used as spreading codes. In LTE systems, the Zadoff-Chu sequence is used as a CAZAC sequence. A user terminal having low maximum transmission power exhibits lower power density per subcarrier in orthogonal CDMA multiplexing than in distributed FDMA multiplexing, and the error in the reliability of CSI measurement is significant.

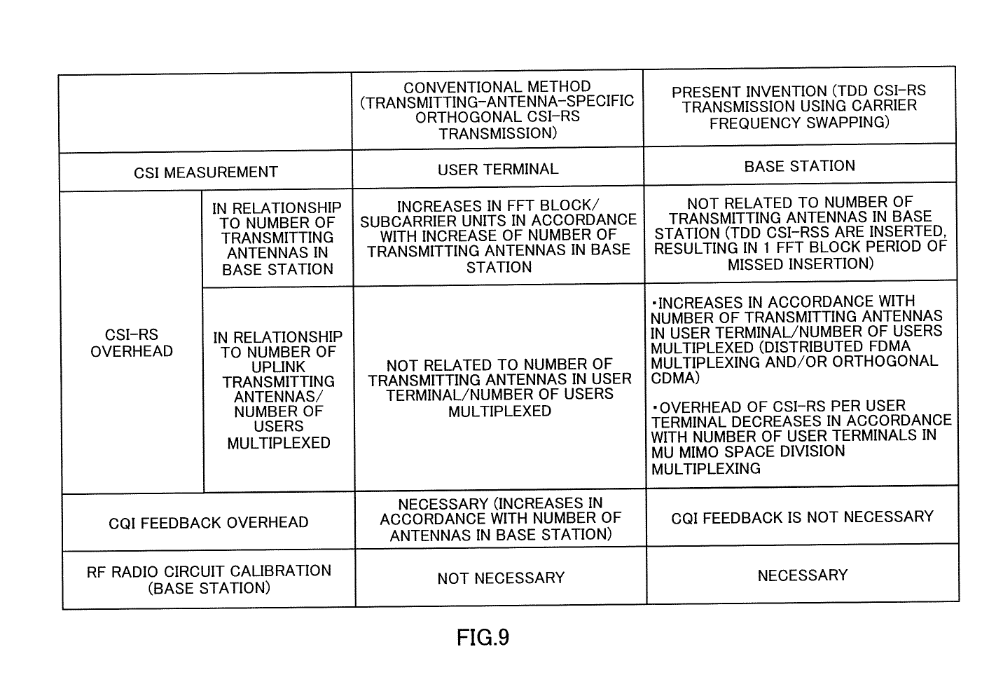

Now, with the aid of FIG. 9, the method of transmitting transmitting-antenna-specific CSI-RSs, which is presented here as a conventional method, and the method of transmitting CSI-RSs by using carrier frequency swapping according to an embodiment of the present invention, which is presented here as the method of proposal, will be compared.

As shown in FIG. 9, according to the conventional method, CSI measurement during MIMO-multiplexing-precoding is conducted by user terminals. On the other hand, according to the method of proposal, this CSI measurement is performed by base stations.

The overhead of CSI-RS and CQI feedback in the conventional method and the proposed method will be shown in comparison. A structure will be assumed here where the antennas are used for both transmission and reception in common, and where the number of antennas in a base station is N_{BS} and the number of antennas in a user terminal is N_{UE}.

In single-user MIMO multiplexing, if N_{BS}=N_{UE} holds, the overhead of transmitting-antenna-specific orthogonal CSI-RSs does not vary between the proposed method and the conventional method. However, in the proposed method, CSI-RSs are transmitted on the uplink, so that the CQI overhead is reduced compared to the conventional method. Furthermore, since CSI is measured directly in the base station, it is possible to reduce the deterioration of the reliability of measurement due to the quantization of CQI feedback.

In multi-user (MU) MIMO multiplexing, if N_{BS}>N_{UE} holds, according to the proposed method, each user terminal has only to transmit N_{UE} or an equivalent number of orthogonal CSI-RSs, so that, compared to the conventional method, the overhead of orthogonal CSI-RSs per user terminal can be reduced significantly. Also, in comparison to the conventional method, the proposed method is the same as SU-MIMO in that the overhead of CQI feedback can be reduced.

According to the conventional method, calibration to correct the deviation of phase or amplitude in the RF transmission section and receiving section circuitry in base stations is not necessary. The proposed method, on the other hand, requires this calibration.

Furthermore, the proposed method is different from the conventional method in that the number of resource elements that can be used in the main link in subframes decreases. By this means, with the proposed method, the number of reference signals that miss insertion can be made slightly less.

As described above, according to the proposed method of transmitting CSI-RSs by using carrier frequency swapping, the overhead of CSI-RS and CQI feedback can be reduced compared to the conventional method.

(Structure of Radio Communications System)

Now, a structure of a radio communications system according to the present embodiment will be described below. In this radio communications system, the above-described TDD CSI-RS transmission method to use carrier frequency swapping is employed.

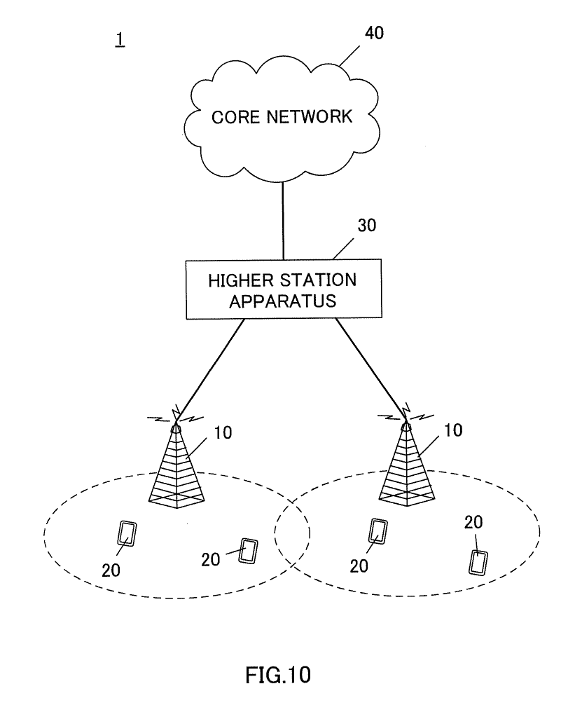

FIG. 10 is a schematic structure diagram to show an example of a radio communications system according to the present embodiment. As shown in FIG. 10, the radio communications system 1 has a plurality of radio base stations 10, a plurality of user terminals 20 that are located in cells formed by each radio base station 10 and that are configured be capable of communicating with each radio base station 10. The radio base stations 10 are each connected with a higher station apparatus 30, and are connected to a core network 40 via the higher station apparatus 30.

The radio base stations 10 are radio base stations that have predetermined coverages. Note that a radio base station 10 may be a macro base station (also referred to as “eNodeB,” “macro base station,” “central node,” “transmission point,” “transmitting/receiving point,” etc.) to have a relatively wide coverage, or may be a small base station (also referred to as “small base station,” “pico base station,” “femto base station,” “HeNB” (Home eNodeB), “RRH” (Remote Radio Head), “micro base station,” “transmission point,” “transmitting/receiving point,” etc.) to have a local coverage.

The user terminals 20 are terminals to support various communication schemes such as LTE, LTE-A and so on, and may include both mobile communication terminals and stationary communication terminals. A user terminal 20 can communicate with other user terminals 20 via the radio base stations 10.

Note that the higher station apparatus 30 may be, for example, an access gateway apparatus, a radio network controller (RNC), a mobility management entity (MME) and so on, but is by no means limited to these.

Also, in the radio communications system 1, a downlink shared channel (PDSCH: Physical Downlink Shared Channel), which is used by each user terminal 20 on a shared basis, downlink control channels (PDCCH (Physical Downlink Control Channel), EPDCCH (Enhanced Physical Downlink Control Channel), etc.), a broadcast channel (PBCH) and so on are used as downlink channels. User data, higher layer control information and predetermined SIBs (System Information Blocks) are communicated by the PDSCH. Downlink control information (DCI) is communicated by the PDCCH and the EPDCCH.

In the radio communications system 1, an uplink shared channel (PUSCH: Physical Uplink Shared Channel), which is used by each user terminal 20 on a shared basis, and an uplink control channel (PDCCH: Physical Uplink Control Channel) and so on are used as uplink channels. User data and higher layer control information are communicated by the PUSCH.

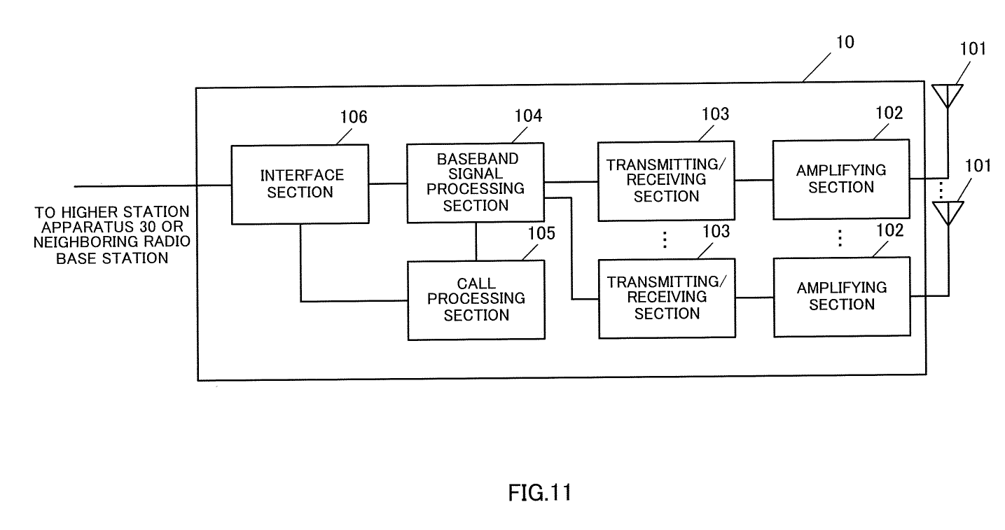

FIG. 11 is a diagram to show an overall structure of a radio base station 10 according to the present embodiment. As shown in FIG. 11, the radio base station 10 has a plurality of transmitting/receiving antennas 101 for MIMO communication, amplifying sections 102, transmitting/receiving sections 103, a baseband signal processing section 104, a call processing section 105 and an interface section 106.

User data to be transmitted from the radio base station 10 to a user terminal 20 on the downlink is input from the higher station apparatus 30, into the baseband signal processing section 104, via the interface section 106.

In the baseband signal processing section 104, a PDCP layer process, division and coupling of user data, RLC (Radio Link control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a pre-coding process are performed, and the result is forwarded to each transmitting/receiving section 103. Furthermore, downlink control signals are also subjected to transmission processes such as channel coding and an inverse fast Fourier transform, and are forwarded to each transmitting/receiving section 103.

Each transmitting/receiving section 103 converts a downlink signal, pre-coded and output from the baseband signal processing section 104 per antenna, into a radio frequency band. The amplifying sections 102 amplify the radio frequency signals having been subjected to frequency conversion, and transmit the signals through the transmitting/receiving antennas 101.

On the other hand, as for uplink signals, radio frequency signals that are received in the transmitting/receiving antennas 101 are each amplified in the amplifying sections 102, converted into the baseband signal through frequency conversion in each transmitting/receiving section 103, and input into the baseband signal processing section 104.

Each transmitting/receiving section 103 receives the TDD CSI-RSs that are transmitted from a plurality of antennas provide in the user terminal 20. Each transmitting/receiving section 103 transmits the downlink PDSCH in MIMO multiplexing transmission by using a selected precoding vector. The transmitting/receiving sections 103 apply MIMO multiplexing to transmission streams, the number of which is determined in a channel estimation section to be described later, and transmits PDSCHs in MIMO multiplexing transmission.

In the baseband signal processing section 104, the user data that is included in the input uplink signals is subjected to an FFT process, an IDFT process, error correction decoding, a MAC retransmission control receiving process, and RLC layer and PDCP layer receiving processes, and the result is forwarded to the higher station apparatus 30 via the interface section 106. The call processing section 105 performs call processing such as setting up and releasing communication channels, manages the state of the radio base station 10 and manages the radio resources.

The interface section 106 transmits and receives signals to and from neighboring radio base stations (backhaul signaling) via an inter-base station interface (for example, optical fiber, the X2 interface, etc.). Alternatively, the interface section 106 transmits and receives signals to and from the higher station apparatus 30 via a predetermined interface.

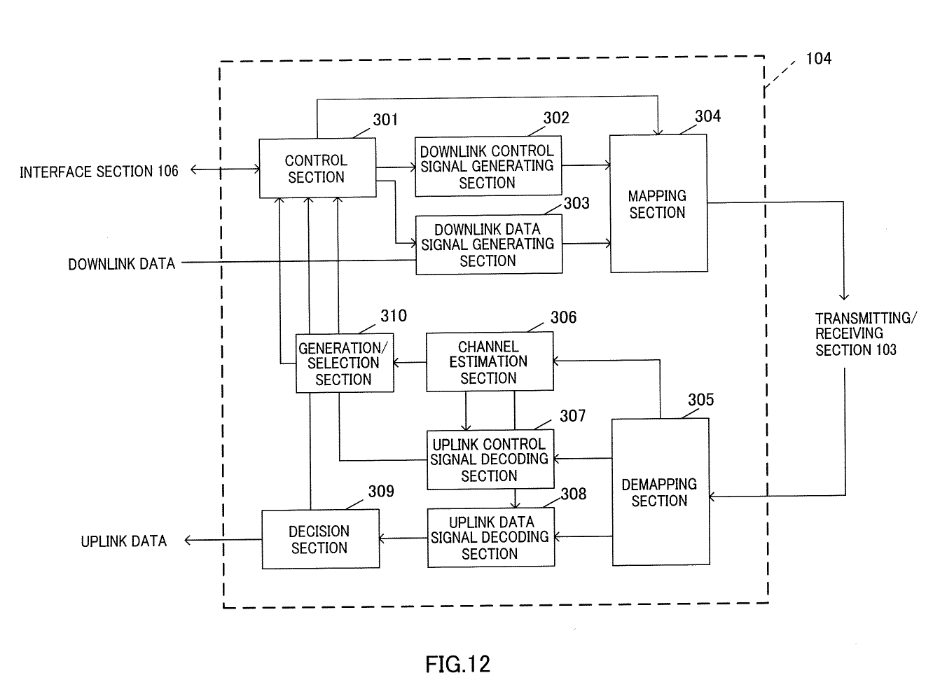

FIG. 12 is a diagram to show a principle functional structure of the baseband signal processing section 104 provided in the radio base station 10 according to the present embodiment. As shown in FIG. 12, the baseband signal processing section 104 provided in the radio base station 10 is comprised at least of a control section 301, a downlink control signal generating section 302, a downlink data signal generating section 303, a mapping section 304, a demapping section 305, a channel estimation section 306, an uplink control signal decoding section 307, an uplink data signal decoding section 308, a decision section 309 and a generation/selection section 310.

The control section 301 controls the scheduling of downlink user data that is transmitted in the PDSCH, downlink control information that is communicated in one or both of the PDCCH and the enhanced PDCCH (EPDCCH), downlink reference signals and so on. Also, the control section 301 controls the scheduling of RA preambles communicated in the PRACH, uplink data that is communicated in the PUSCH, uplink control information that is communicated in the PUCCH or the PUSCH, and uplink reference signals (allocation control). Information about the allocation control of uplink signals (uplink control signals, uplink user data, etc.) is reported to the user terminal 20 by using a downlink control signal (DCI).

The control section 301 controls the allocation of radio resources to downlink signals and uplink signals based on command information from the higher station apparatus 30, feedback information from each user terminal 20, and so on. That is, the control section 301 functions as a scheduler.

The downlink control signal generating section 302 generates downlink control signals (which may be both PDCCH signals and EPDCCH signals, or may be one of these) that are determined to be allocated by the control section 301. To be more specific, the downlink control signal generating section 302 generates a DL assignment, which reports downlink signal allocation information, and a UL grant, which reports uplink signal allocation information, based on commands from the control section 301.

The downlink data signal generating section 303 generates downlink data signals (PDSCH signals) that are determined to be allocated to resources by the control section 301. The data signals that are generated in the data signal generating section 303 are subjected to a channel coding process and a modulation process, based on channel coding rates and modulation schemes that are determined based on CSI from each user terminal 20 and so on.

The mapping section 304 controls the allocation of the downlink control signals generated in the downlink control signal generating section 302 and the downlink data signals generated in the downlink data signal generating section 303 to radio resources based on commands from the control section 301.

The demapping section 305 demaps an uplink signal transmitted from the user terminal 20 and separates the uplink signal. The channel estimation section 306 estimates channel states from the reference signals included in the received signals separated in the demapping section 305, and outputs the estimated channel states to the uplink control signal decoding section 307 and the uplink data signal decoding section 308. That is, the channel estimation section 306 functions as a measurement section that measures CSI by using the TDD CSI-RSs that are received. Also, the channel estimation section 306 calculates an optimal number of transmission streams from the CSIs measured per receiving antenna.

The uplink control signal decoding section 307 decodes the feedback signal (delivery acknowledgement signals and/or the like) transmitted from the user terminal in the uplink control channel (PRACH, PUCCH, etc.), and outputs the result to the control section 301. The uplink data signal decoding section 308 decodes the uplink data signal transmitted from the user terminal through the uplink shared channel (PUSCH), and outputs the result to the decision section 309. The decision section 309 makes a retransmission control decision (A/N decisions) based on the decoding result in the uplink data signal decoding section 308, and outputs result to the control section 301.

The generation/selection section 310 generates an optimal precoding vector from the CSI measured in each receiving antenna. Also, the generation/selection section 310 selects an optimal precoding vector from the codebook based on the CSI that is measured in each receiving antenna.

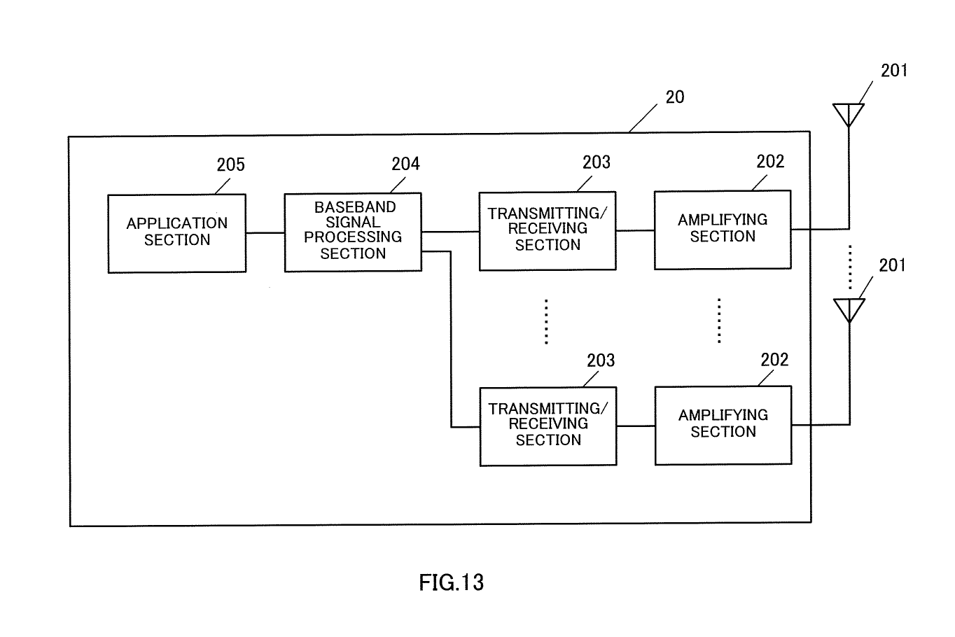

FIG. 13 is a diagram to show an overall structure of a user terminal 20 according to the present embodiment. As shown in FIG. 13, the user terminal 20 has a plurality of transmitting/receiving antennas 201 for MIMO communication, amplifying sections 202, transmitting/receiving sections (receiving sections) 203, a baseband signal processing section 204 and an application section 205.

As for downlink data, radio frequency signals that are received in the plurality of transmitting/receiving antennas 201 are each amplified in the amplifying sections 202, and subjected to frequency conversion and converted into the baseband signal in the transmitting/receiving sections 203. This baseband signal is subjected to an FFT process, error correction decoding, a retransmission control receiving process and so on in the baseband signal processing section 204. In this downlink data, downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. In the baseband signal processing section 204, a retransmission control (H-ARQ (Hybrid ARQ)) transmission process, channel coding, precoding, a DFT process, an IFFT process and so on are performed, and the result is forwarded to each transmitting/receiving section 203. The transmitting/receiving section 203 convert the baseband signal output from the baseband signal processing section 204 into a radio frequency band. After that, the amplifying sections 202 amplify the radio frequency signal having been subjected to frequency conversion, and transmit the resulting signal from the transmitting/receiving antennas 201.

The transmitting/receiving sections 203 transmit TDD CSI-RSs in the downlink carrier frequency by using, for example, one or a plurality of FFT blocks in a subframe.

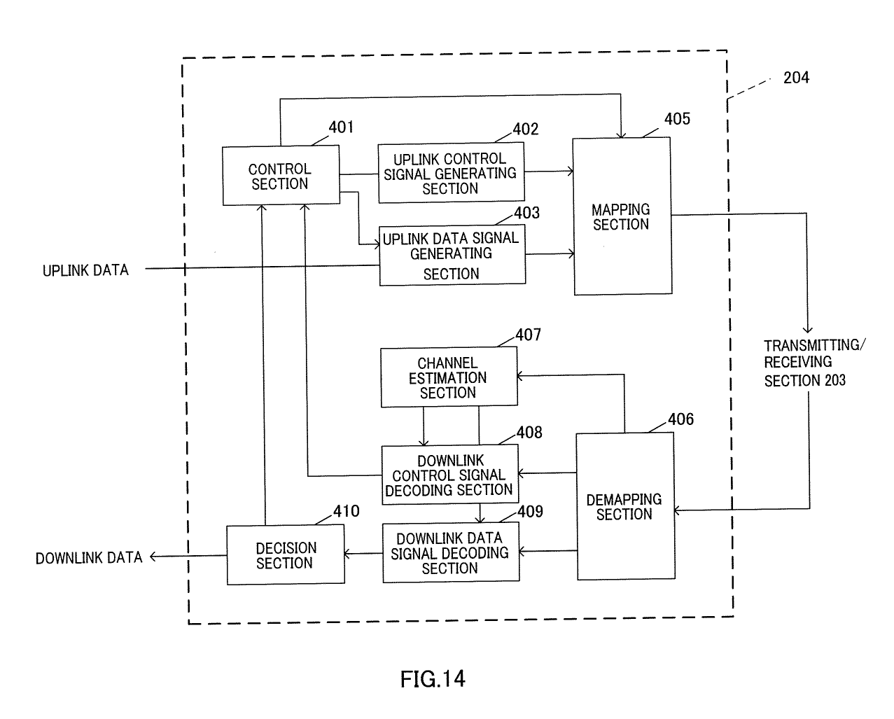

FIG. 14 is a diagram to show a principle functional structure of the baseband signal processing section 204 provided in a user terminal 20. As shown in FIG. 14, the baseband signal processing section 204 provided in the user terminal 20 is comprised at least of a control section 401, an uplink control signal generating section 402, an uplink data signal generating section 403, a mapping section 405, a demapping section 406, a channel estimation section 407, a downlink control signal decoding section 408, a downlink data signal decoding section 409 and a decision section 410.

The control section 401 controls the generation of uplink control signals (A/N signals and so on) and uplink data signals based on downlink control signals (PDCCH signals) transmitted from the radio base stations, retransmission control decisions with respect to the PDSCH signals received, and so on. The downlink control signals received from the radio base station are output from the downlink control signal decoding section 408, and the retransmission control decisions are output from the decision section 410.

The uplink control signal generating section 402 generates uplink control signals (feedback signals such as delivery acknowledgement signals, channel state information (CSI) and so on) based on commands from the control section 401. The uplink data signal generating section 403 generates uplink data signals based on commands from the control section 401. Note that, when a UL grant is contained in a downlink control signal reported from the radio base station, the control section 401 commands the uplink data signal generating section 403 to generate an uplink data signal.

The mapping section 405 controls the allocation of the uplink control signals (delivery acknowledgment signals and so on) and the uplink data signals to radio resources (PUCCH, PUSCH, etc.) based on commands from the control section 401.

The demapping section 406 demaps the downlink signals transmitted from the radio base station 10 and separates the downlink signals. The channel estimation section 407 estimates channel states from the reference signals included in the received signals separated in the demapping section 406, and outputs the estimated channel states to the downlink control signal decoding section 408 and the downlink data signal decoding section 409.

The downlink control signal decoding section 408 decodes the downlink control signal (PDCCH signal) transmitted in the downlink control channel (PDCCH), and outputs the scheduling information (information regarding the allocation to uplink resources) to the control section 401. Also, when information related to the cell to feed back delivery acknowledgement signals or information as to whether or not to apply RF tuning is included in a downlink control signal, these pieces of information are also output to the control section 401.

The downlink data signal decoding section 409 decodes the downlink data signals transmitted in the downlink shared channel (PDSCH), and outputs the results to the decision section 410. The decision section 410 makes a retransmission control decision (A/N decision) based on the decoding result in the downlink data signal decoding section 409, and outputs the result to the control section 401.

The present invention is by no means limited to the above embodiment and can be implemented with various changes. The sizes and shapes illustrated in the accompanying drawings in relationship to the above embodiment are by no means limiting, and may be changed as appropriate within the scope of optimizing the effects of the present invention. Besides, implementations with various appropriate changes may be possible without departing from the scope of the object of the present invention.

This application is based on Japanese Patent Application No. 2014-038647, filed on Feb. 28, 2014, including the specification, drawings and abstract, is incorporated herein by reference in its entirety.

1. A radio base station that is used in a radio communications system of a frequency division duplexing (FDD) scheme, the radio base station comprising:
a receiving section that receives reference signals for measuring time division duplex (TDD) channel state information, transmitted from a plurality of antennas provided in a user terminal;
a measurement section that measures the channel state information, in a plurality of receiving antennas, by using the reference signals;
a generation/selection section that generates an optimal precoding vector from the channel state information measured in each receiving antenna, or selects the optimal precoding vector from a set of precoding vectors that is defined in advance; and
a transmission section that transmits a physical downlink shared channel, in MIMO multiplexing transmission, by using the precoding vector selected in the generation/selection section.

2. (canceled)

3. The radio base station according to claim 1, wherein the reference signals for measuring the TDD channel state information are transmitted from the user terminal, in a downlink carrier frequency, by using a transmission period of one or a plurality of FFT blocks in an uplink subframe.

4. The radio base station according to claim 1, wherein the reference signals for measuring the TDD channel state information are transmitted in an uplink carrier frequency by using a transmission period of one or a plurality of FFT blocks in a downlink subframe.

5. The radio base station according to claim 3, wherein the reference signals for measuring the channel state information are transmitted and received in distributed FDMA multiplexing.

6. The radio base station according to claim 3, wherein the reference signals for measuring the channel state information are transmitted and received in orthogonal CDMA multiplexing.

7. A user terminal that is used in a radio communications system of a frequency division duplexing (FDD) scheme, the user terminal comprising:
a transmission section that transmits reference signals for measuring time division duplex (TDD) channel state information, in a downlink carrier frequency, by using one or a plurality of FFT blocks in an uplink subframe, and
a receiving section that receives reference signals for measuring time division duplex (TDD) channel state information, transmitted from a radio base station in an uplink carrier frequency, by using a transmission period of one or a plurality of FFT blocks in a downlink subframe.

8. (canceled)

9. The user terminal according to claim 7, wherein the transmission section multiplexes and transmits uplink control information, in a transmission period in which, in uplink, the reference signals for measuring the channel state information are transmitted using a downlink carrier frequency.

10. A radio communications method in a radio base station used in a radio communications system of a frequency division duplexing (FDD) scheme, the radio communication method comprising the steps of:
receiving reference signals for measuring time division duplex (TDD) channel state information, transmitted from a plurality of antennas provided in a user terminal;
measuring the channel state information, in a plurality of receiving antennas, by using the reference signals;
selecting an optimal precoding vector from the channel state information measured in each receiving antenna; and
transmitting a physical downlink shared channel, in MIMO multiplexing transmission, by using the selected precoding vector.

11. The radio base station according to one of claim 4, wherein the reference signals for measuring the channel state information are transmitted and received in distributed FDMA multiplexing.

12. The radio base station according to one of claim 4, wherein the reference signals for measuring the channel state information are transmitted and received in orthogonal CDMA multiplexing.
